(19) United States
(12) Patent Application Publication
(10) Pub. No.: US 2021/0035384 A1
(43) Pub. Date: Feb. 4, 2021

(54) METHODS AND SYSTEMS FOR DETERMINING A DRIVER PENALTY SCORE BASED ON HARSH DRIVING EVENTS

(71) Applicant: Toyota Connected North America, Inc., Plano, TX (US)

(72) Inventors: Raja Shekar Kilaru, Addison, TX (US); Akshata Dundi Mohan, Addison, TX (US); Nimish Kumar Amlathe, Plano, TX (US)

(73) Assignee: Toyota Connected North America, Inc., Plano, TX (US)

(21) Appl. No.: 16/526,330

(22) Filed: Jul. 30, 2019

(51) Int. Cl. G07C 5/08

(52) U.S. Cl. CPC G07C 5/085

(57) ABSTRACT

In an embodiment, a driver-scoring device detects harsh events performed by an operator of a vehicle driven a number of distance units by the operator during a first period of time. Each of the detected harsh events has a respective g-force exceeding a threshold g-force. The driver-scoring device determines a penalty score including a ratio of a harsh-event score added to a sum of respective event-penalty scores for each of the detected harsh events to a metric score parameter. The harsh-event score includes a ratio of a number of the detected harsh events to the number of distance units driven by the operator during the first period of time. The respective event-penalty score for each of the detected harsh events includes a respective ratio of a penalty factor associated with the detected harsh event to the number of distance units driven by the operator during the first period of time.

### TECHNICAL FIELD

The present disclosure generally relates to driver-scoring devices and methods carried out by driver-scoring devices, and more specifically, to driver-scoring devices and methods for determining a penalty score based on harsh driving events.

### BACKGROUND

Vehicles such as automobiles, cars, trucks, and buses may perform a variety of maneuvers while traveling on a road. These maneuvers may cause the vehicles to experience g-forces that, in some instances, may exceed desirable levels for the vehicles. For example, excessive g-forces could result in loss of traction or rollovers, which present undesirable conditions.

### SUMMARY

An embodiment of the present disclosure takes the form of a method carried out by a scoring device. The method includes detecting one or more harsh events performed by an operator of at least one vehicle driven a number of distance units by the operator during a first period of time. Each of the detected harsh events includes a respective detected event performed by the operator and having a g-force exceeding a threshold g-force. The method further includes determining a penalty score that includes a ratio of a harsh-event score added to a sum of respective event-penalty scores for each of the detected harsh events to a metric score parameter. The harsh-event score includes a ratio of a number of the detected harsh events to the number of distance units driven by the operator during the first period of time. The respective event-penalty score for each of the detected harsh events includes a respective ratio of a penalty factor associated with the detected harsh event to the number of distance units driven by the operator during the first period of time. The metric score parameter is based on a given bottom percentile of respective driver-event ratios for each of a plurality of operators of vehicles. Each driver-event ratio includes a respective ratio of a number of events, performed by the respective operator during a second period of time and having respective g-forces exceeding the threshold g-force, to a respective number of distance units driven by the respective operator during the second period of time.

Another embodiment takes the form of a driver-scoring device that includes a processor and a non-transitory computer-readable storage medium having instructions that, when executed by the processor, cause the driver-scoring device to detect one or more harsh events performed by an operator of at least one vehicle driven a number of distance units by the operator during a first period of time. Each of the detected harsh events includes a respective detected event performed by the operator and having a g-force exceeding a threshold g-force. The instructions further cause the driver-scoring device to determine a penalty score that includes a ratio of a harsh-event score added to a sum of respective event-penalty scores for each of the detected harsh events to a metric score parameter. The harsh-event score includes a ratio of a number of the detected harsh events to the number of distance units driven by the operator during the first period of time. The respective event-penalty score for each of the detected harsh events includes a respective ratio of a penalty factor associated with the detected harsh event to the number of distance units driven by the operator during the first period of time. The metric score parameter is based on a given bottom percentile of respective driver-event ratios for each of a plurality of operators of vehicles. Each driver-event ratio includes a respective ratio of a number of events, performed by the respective operator during a second period of time and having respective g-forces exceeding the threshold g-force, to a respective number of distance units driven by the respective operator during the second period of time.

A further embodiment takes the form of a method carried out by a driver-scoring device. The method includes detecting one or more harsh events performed by an operator of at least one vehicle driven a number of distance units by the operator during a first period of time. Each of the detected harsh events includes a respective detected event performed by the operator and having a g-force exceeding a threshold g-force. The method further includes determining a harsh-event score that includes a ratio of a number of the detected harsh events to the number of distance units driven by the operator during the first period of time. Additionally, the method includes determining, for each of the detected harsh events, a respective event-penalty score that includes a respective ratio of a penalty factor associated with the detected harsh event to the number of distance units driven by the operator during the first period of time. The method also includes determining a penalty score that includes a ratio of the determined harsh-event score added to a sum of the determined respective event-penalty scores to a metric score parameter. The metric score parameter is based on a given bottom percentile of respective driver-event ratios for each of a plurality of operators of vehicles. Each driver-event ratio includes a respective ratio of a number of events, performed by the respective operator during a second period of time and having respective g-forces exceeding the threshold g-force, to a respective number of distance units driven by the respective operator during the second period of time.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a driver-scoring system, according to one or more embodiments described and illustrated herein;

FIG. 2 depicts a block diagram of a driver-scoring device, according to one or more embodiments described and illustrated herein;

FIG. 3 depicts a driver-scoring device determining a penalty score, according to one or more embodiments described and illustrated herein;

FIG. 4 depicts a flowchart of a method carried out by a driver-scoring device, according to one or more embodiments described and illustrated herein;

FIG. 5a depicts detected events performed by a vehicle operator, according to one or more embodiments described and illustrated herein;

FIG. 5b depicts harsh events performed by a vehicle operator, according to one or more embodiments described and illustrated herein;

FIG. 5c depicts a distribution of g-forces for events performed by a plurality of vehicle operators, according to one or more embodiments described and illustrated herein;

FIG. 6 depicts aspects of a harsh-event score, according to one or more embodiments described and illustrated herein;

FIG. 7a depicts aspects of penalty factors associated with detected harsh events, according to one or more embodiments described and illustrated herein;

FIG. 7b depicts aspects of event-penalty scores for detected harsh events, according to one or more embodiments described and illustrated herein;

FIG. 7c depicts g-forces that exceed a threshold g-force, according to one or more embodiments described and illustrated herein;

FIG. 8a depicts events performed by a plurality of vehicle operators, according to one or more embodiments described and illustrated herein;

FIG. 8b depicts respective driver-event ratios for each of a plurality of vehicle operators, according to one or more embodiments described and illustrated herein;

FIG. 8c depicts a distribution of driver-event ratios, according to one or more embodiments described and illustrated herein;

FIG. 9 depicts aspects of determining a penalty score, according to one or more embodiments described and illustrated herein; and

FIG. 10 depicts a flowchart of a method carried out by a driver-scoring device, according to one or more embodiments described and illustrated herein.

### DETAILED DESCRIPTION

Driver-scoring systems, driver-scoring devices, and methods carried out by driver-scoring systems and driver-scoring devices for determining a penalty score of a vehicle operator are disclosed herein. In some embodiments, a driver-scoring device detects one or more harsh events performed by an operator of at least one vehicle driven a number of distance units by the operator during a first period of time. Each of the detected harsh events includes a respective detected event performed by the operator and having a g-force exceeding a threshold g-force. The driver-scoring device determines a penalty score that includes a ratio of a harsh-event score added to a sum of respective event-penalty scores for each of the detected harsh events to a metric score parameter. The harsh-event score includes a ratio of a number of the detected harsh events to the number of distance units driven by the operator during the first period of time. The respective event-penalty score for each of the detected harsh events includes a respective ratio of a penalty factor associated with the detected harsh event to the number of distance units driven by the operator during the first period of time. The metric score parameter is based on a given bottom percentile of respective driver-event ratios for each of a plurality of operators of vehicles. Each driver-event ratio includes a respective ratio of a number of events, performed by the respective operator during a second period of time and having respective g-forces exceeding the threshold g-force, to a respective number of distance units driven by the respective operator during the second period of time. By determining the metric score parameter based on driver-event ratios for a plurality of vehicle operators, the threshold g-force need not be a static threshold, but could be a dynamic threshold based on historical anonymized driving data for the plurality of operators. Various embodiments of driver-scoring systems, driver-scoring devices, and methods for determining a penalty score of a vehicle operator will now be described in detail with reference to the drawings.

### Driver-Scoring System and Device

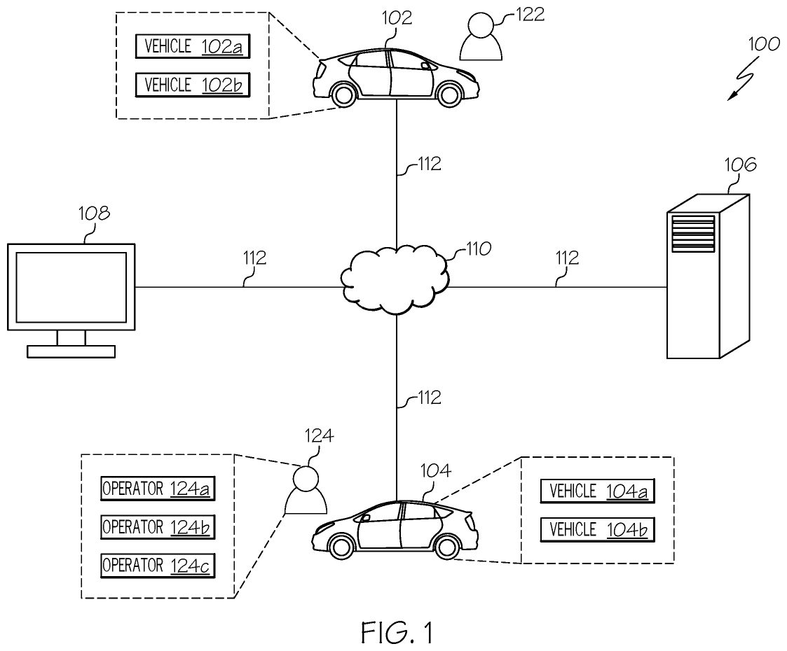

FIG. 1 depicts a driver-scoring system, according to one or more embodiments described and illustrated herein. As shown, a system 100 includes at least one vehicle 102 driven by an operator 122, vehicles 104 driven by a plurality of operators 124, a server computer 106, and a user terminal 108, each of which are communicatively connected via a network 110 and respective communication links 112 to network 110.

The at least one vehicle 102 and/or any of vehicles 104 could take the form of an autonomous vehicle, a semi-autonomous vehicle, or a manually-operated vehicle, among other possibilities. The vehicle could include a computing device configured to carry out the vehicle functions or the driver-scoring functions described herein. In the illustrated embodiment, the at least one vehicle 102 includes vehicle 102a and vehicle 102b, and vehicles 104 include a vehicle 104a and a vehicle 104b. Those of skill in the art will appreciate that the at least one vehicle 102 and/or vehicles 104 may include additional and/or fewer vehicles.

Server computer 106 could take the form of a mainframe, a workstation, a terminal, a personal computer, a virtual machine, or any combination of these or other server computers. The server could take the form of (or include) a computing device configured to carry out the server-computer functions or the driver-scoring functions described herein. Though system 100 is shown as including a single server computer, those of skill in the art will appreciate that the system could include multiple server computers.

User terminal 108 may be any component capable of carrying out the user-terminal functions described herein, and could take the form of (or include) a workstation, a terminal, a personal computer, a tablet device, a smartphone, or any combination of these, as just a few examples. The user terminal may include a user interface configured to output information to a user and/or receive input from the user. In an embodiment, user terminal 108 is configured to present output, received from a computing device (such as server computer 106) via the user interface. In a further embodiment, the user terminal is configured to provide input, received via the user interface, to the computing device. The output may be received (and/or the input provided) over network 110 via one or more communication links 112. User terminal 108 may take other forms as well.

Network 110 may include one or more computing systems and network infrastructure configured to facilitate communication between any one or more of the at least one vehicle 102, vehicles 104, server computer 106, and user terminal 108. The network may take the form of (or include) one or more Wide-Area Networks (WANs), Local-Area Networks (LANs), the Internet, cellular networks, wired networks, wireless networks, or any combination of these or other networks. Network 110 may operate according to one or more communication protocols such as Ethernet, WiFi, IP, TCP, or LTE, as examples. Though the network is shown as a single network, it should be understood that the network may include multiple, distinct networks that are communicatively linked. The network could take other forms as well. Additionally, the communication links may include one or more intermediate paths or systems, for example.

Communication links 112 may communicatively link respective entities with network 110 to facilitate communication between entities communicatively connected to the network. Any of communication links 112 may be a combination of hardware and/or software, perhaps operating on one or more communication-link layers such as one or more physical, network, transport, and/or application layers.

Those of skill in the art will appreciate that system 100 may include different and/or additional entities. For example, though the plurality of operators 124 is shown to include an operator 124a, an operator 124b, and an operator 124c, those of skill in the art will appreciate that the plurality of operators 124 may include additional and/or fewer operators. Moreover, one or more communication links may be absent, such as communication links between network 110 and vehicles 104 and/or the at least one vehicle 102. In some embodiments, server computer 106 and/or user terminal 108 are absent, or the functions of these entities are combined into a single device. Other variations are possible as well.

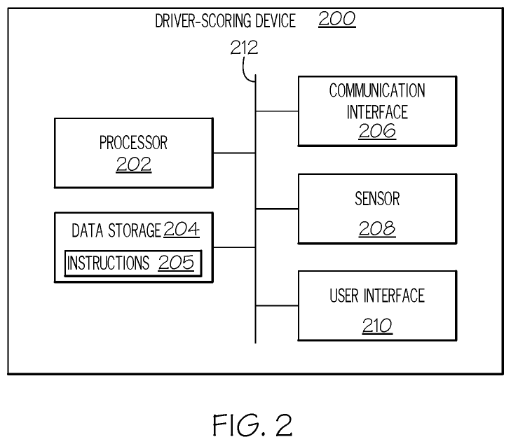

FIG. 2 depicts a block diagram of a driver-scoring device, according to one or more embodiments described and illustrated herein. As shown, a driver-scoring device 200 includes a processor 202, a data storage 204 including instructions 205, a communication interface 206, a sensor 208, and a user interface 210, each of which are communicatively connected via a system bus 212. The driver-scoring device could take the form of the at least one vehicle 102, vehicles 104, server computer 106, user terminal 108, or any combination of these or other driver-scoring devices. It should be understood that driver-scoring device 200 may include different and/or additional components, and some or all of the functions of a given component could instead be carried out by one or more different components.

Processor 202 may take the form of one or more general-purpose processors and/or one or more special-purpose processors, and may be integrated in whole or in part with data storage 204, communication interface 206, sensor 208, user interface 210, and/or any other component of driver-scoring device 200, as examples. Accordingly, processor 202 may take the form of or include a controller, an integrated circuit, a microchip, a central processing unit (CPU), a microprocessor, a system on a chip (SoC), a field-programmable gate array (FPGA), and/or an application-specific integrated circuit (ASIC), among other possibilities.

Data storage 204 may take the form of a non-transitory computer-readable storage medium such as a hard drive, a solid-state drive, an erasable programmable read-only memory (EPROM), a universal serial bus (USB) storage device, a compact disc read-only memory (CD-ROM) disk, a digital versatile disc (DVD), a relational database management system (RDBMS), any other non-volatile storage, or any combination of these, to name just a few examples.

Instructions 205 may be stored in data storage 204, and may include machine-language instructions executable by processor 202 to cause driver-scoring device 200 to perform the driver-scoring-device functions described herein. Additionally or alternatively, instructions 205 may include script instructions executable by a script interpreter configured to cause processor 202 and driver-scoring device 200 to execute the instructions specified in the script instructions. Those having skill in the art will recognize that instructions 205 may take other forms as well.

Additional data may be stored in data storage 204, such as driving data for the plurality of operators 124, as will be described in further detail below. The additional data such as the could be stored as a table, a flat file, data in a filesystem of the data storage, a heap file, a B+ tree, a hash table, a hash bucket, or any combination of these, as examples.

Communication interface 206 may be any component capable of performing the communication-interface functions described herein. As such, communication interface 206 could take the form of an Ethernet, Wi-Fi, Bluetooth, and/or USB interface, among many other examples. Communication interface 206 may receive data over network 110 via communication links 112, for instance.

Sensor 208 could take the form of one or more sensors operable to perform any of the sensor functions described herein. For example, the sensor could take the form of an accelerometer or other sensor configured to determine respective g-forces of detected events. To illustrate, driver-scoring device 200 could take the form of the at least one vehicle 102 and/or any of vehicles 104, and the sensor may detect or determine g-forces of detected events performed by an operator of the driver-scoring device. Though sensor 208 may be referenced in the singular throughout this disclosure, those of skill in the art will appreciate that sensor 208 may take the form of (or include) a single sensor or multiple sensors. Sensor 208 may take other forms as well.

User interface 210 may be any component capable of carrying out the user-interface functions described herein. For example, the user interface may be configured to receive input from a user and/or output information to the user. Output may be provided via a computer monitor, a loudspeaker (such as a computer speaker), or another component of (or communicatively linked to) driver-scoring device 200. User input might be achieved via a keyboard, a mouse, or other component communicatively linked to the driver-scoring device. As another possibility, input may be realized via a touchscreen display of the driver-scoring device in the form of a smartphone or tablet device. Some components may provide for both input and output, such as the aforementioned touchscreen display. Those having skill in the art will understand that user interface 210 may take numerous other forms as well.

System bus 212 may be any component capable of performing the system-bus functions described herein. In an embodiment, system bus 212 is any component configured to transfer data between processor 202, data storage 204, communication interface 206, sensor 208, user interface 210, and/or any other component of driver-scoring device 200. In an embodiment, system bus 212 includes a traditional bus as is known in the art. In other embodiments, system bus 212 includes a serial RS-232 communication link, a USB communication link, and/or an Ethernet communication link, alone or in combination with a traditional computer bus, among numerous other possibilities. In some examples, system bus 212 may be formed from any medium that is capable of transmitting a signal, such as conductive wires, conductive traces, or optical waveguides, among other possibilities. Moreover, system bus 212 may be formed from a combination of mediums capable of transmitting signals. The system bus could take the form of (or include) a vehicle bus, such as a local interconnect network (LIN) bus, a controller area network (CAN) bus, a vehicle area network (VAN) bus, or any combination of these or mediums. Those of skill in the art will recognize that system bus 212 may take various other forms as well.

### Penalty Score

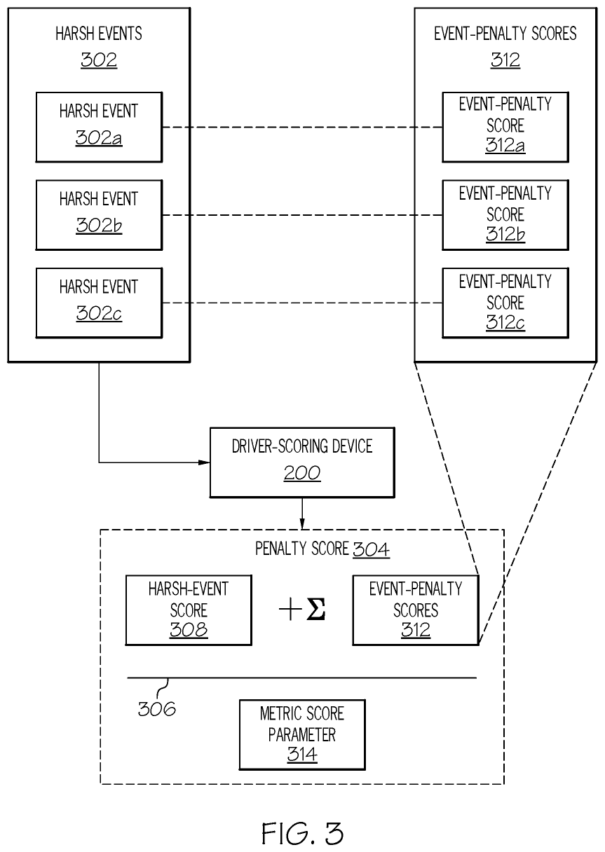

FIG. 3 depicts a driver-scoring device determining a penalty score, according to one or more embodiments described and illustrated herein. As shown, driver-scoring device 200 detects one more harsh events 302, and determines a penalty score 304 that takes the form of (or includes) a ratio 306, of a harsh-event score 308 added to a sum of event-penalty scores 312, to a metric score parameter 314. Event-penalty scores 312 take the form of (or include) respective event-penalty scores for each of the detected harsh events 302. In the illustrated embodiment, event-penalty scores 312 include event-penalty scores 312a, 312b, and 312c for harsh events 302a, 302b, and 302c, respectively. Those of skill in the art will appreciate that the detected harsh events 302 may include additional and/or fewer harsh events, and the event-penalty scores 312 may include additional and/or fewer event-penalty scores.

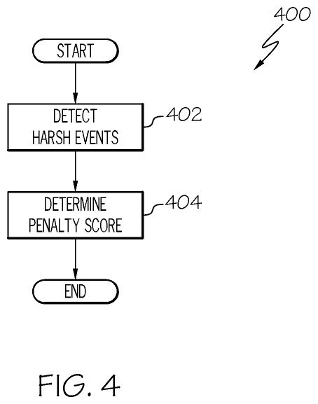

FIG. 4 depicts a flowchart of a method according carried out by a driver-scoring device, according to one or more embodiments described and illustrated herein. As shown, a method 400 begins at step 402 with driver-scoring device 200 detecting one more harsh events 302 performed by operator 122 of the at least one vehicle 102 during a given period of time. Each of the detected harsh events 302 takes the form of (or includes) a respective detected event performed by operator 122 and having a g-force exceeding a threshold g-force. At step 404 of method 400, the driver-scoring device determines penalty score 304 which, as discussed above, takes the form of (or includes) ratio 306, of harsh-event score 308 added to sum of respective event-penalty scores 312, to metric score parameter 314. Aspects of the harsh-event score, the event-penalty scores, and the metric score parameter are described in turn below.

### Detected Events

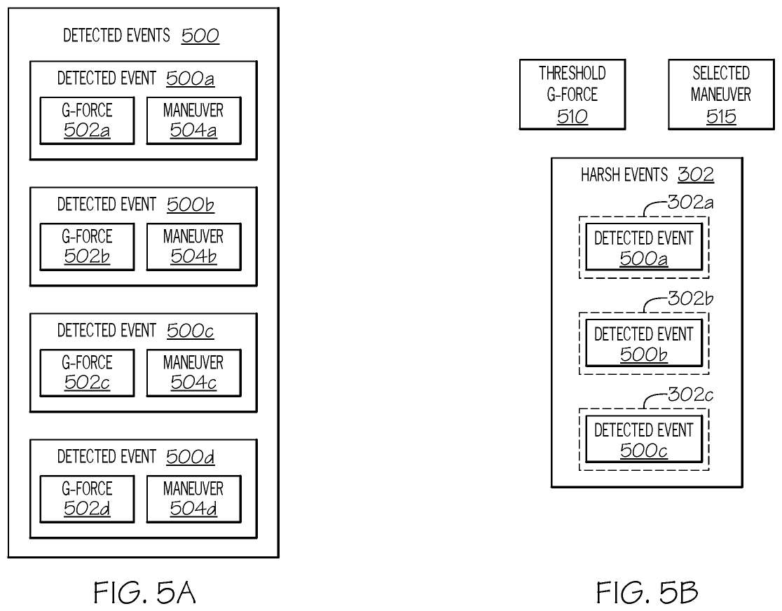

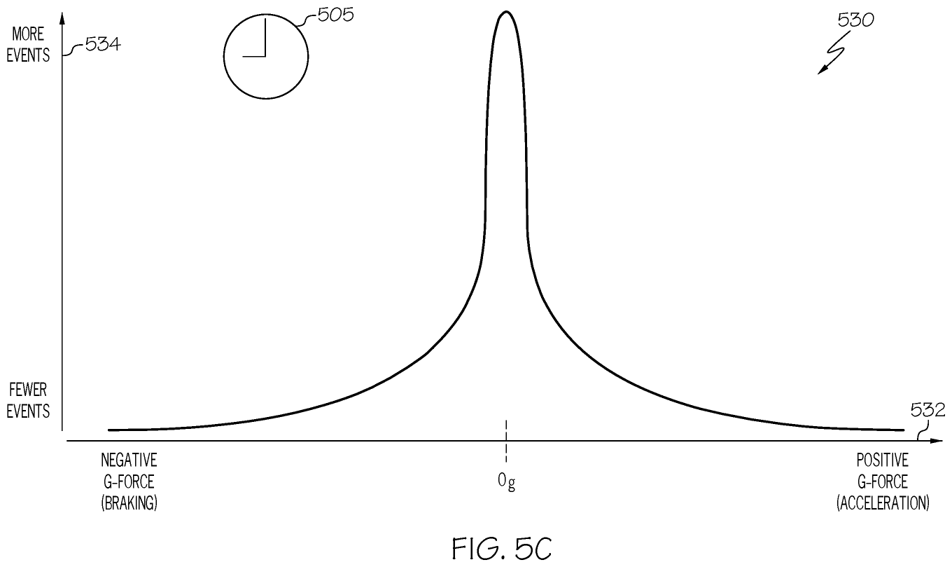

FIG. 5a depicts detected events performed by operator 122, according to one or more embodiments described and illustrated herein. As shown, detected events 500 include detected events 500a, 500b, 500c, and 500d having g-forces 502a, 502b, 502c, and 502d, respectively. In the embodiment of FIG. 5a, g-forces 502a, 502b, and 502c each exceed a threshold g-force 510, but g-force 502d does not exceed the threshold g-force.

Each of detected events 500 may be a maneuver of one or more maneuver types, such as an acceleration maneuver, a braking maneuver, and/or a turning maneuver, as examples. In the embodiment of FIG. 5a, for example, detected events 500a, 500b, 500c, and 500d are maneuvers of type 504a, 504b, 504c, and 504d, respectively. In an embodiment, detecting harsh events 302 includes identifying a respective maneuver type of a maneuver of the respective detected event of each of the detected harsh events.

The g-force of a detected event may be a lateral g-force or a longitudinal g-force, and may be a positive g-force or a negative g-force, as examples. A detected event with a positive longitudinal g-force could be an acceleration maneuver, and a detected event with a negative longitudinal g-force could be a braking maneuver, as examples. Similarly, a detected event with a positive lateral g-force could be a right turn, and a detected event with a negative lateral g-force could be a left turn, for instance. Those of skill in the art will appreciate that an orientation of a longitudinal and/or a lateral axis of the g-forces may vary, and that the sign (e.g., positivity and negativity) of the g-forces on a given axis may be inverted, without departing from the scope of the disclosure. As another possibility, the g-force of a detected event could be represented as an absolute value of the g-force. For instance, a lateral g-force could be an absolute value of the lateral g-force (e.g., such that the g-force is positive regardless of whether the event is a left turn or a right turn), and/or the longitudinal g-force could be an absolute value of the longitudinal g-force. The g-force of a detected event may take other forms as well.

In an embodiment, a maneuver type of a given detected event is based on a direction and/or a sign (positivity/negativity) of the g-force of the event. For example, the maneuver type of an event having a g-force with a positive magnitude on a longitudinal axis may take the form of (or include) an acceleration maneuver, and a maneuver type of an event having a g-force with a negative magnitude on a longitudinal axis may take the form of (or include) a braking maneuver. Likewise, the maneuver type of an event having a g-force with a positive magnitude on a lateral axis may take the form of (or include) a right turn, and a maneuver type of an event having a g-force with a negative magnitude on a lateral axis may take the form of (or include) a left turn, for instance. As a further possibility, a maneuver type of an event having a g-force with a positive or negative magnitude on a lateral axis may take the form of (or include) a turn, such as a turn in either a left or right direction. Additionally, a given event could be a maneuver of multiple maneuver types. For example, an event having a g-force with a positive magnitude on both a longitudinal axis and a lateral axis may take the form of (or include) both an acceleration maneuver and a right turn maneuver. Other examples are possible as well.

### Harsh Events and Threshold G-Force

FIG. 5b depicts harsh events performed by operator 122 of the at least one vehicle 102 driven by operator 122, according to one or more embodiments described and illustrated herein. As shown, each of harsh events 302 takes the form of (or includes) a respective detected event having a respective g-force exceeding a threshold g-force 510. In an embodiment, threshold g-force 510 takes the form of (or includes) a range of g-forces or multiple ranges of g-forces. In such an embodiment, a detected event having a respective g-force that exceeds a threshold g-force 510 takes the form of (or includes) a detected event having a respective g-force that is outside the range (or ranges) of g-forces, within the range (or ranges) of g-forces, or a combination of these, as examples.

In the embodiment illustrated in FIG. 5b, detected harsh events 302 includes harsh events 302a, 302b, and 302c, which take the form of (or include) detected events 500a, 500b, and 500c, respectively. As noted above, g-forces 502a, 502b, and 502c of detected events 500a, 500b, and 500c, respectively, each exceed a threshold g-force 510. Detected event 500d is not included among harsh events 302 because g-force 502d does not exceed the threshold g-force.

In an embodiment, threshold g-force 510 is based on a g-force at a given percentile of g-forces in a distribution of respective g-forces for detected events. An example distribution is shown in FIG. 5c.

FIG. 5c depicts a distribution of respective g-forces for detected events performed by operators 124 of vehicles 104, according to one or more embodiments described and illustrated herein. As shown, a distribution 530 takes the form of a distribution of g-forces for detected events performed during a period of time 505. A horizontal axis 532 indicates a g-force for a respective detected event, and vertical axis 534 indicates a number of detected events having the g-force indicated on the horizontal axis.

In an embodiment, the g-forces of distribution 530 take the form of longitudinal g-forces that increase by a negative magnitude toward the left end of horizontal axis 532, and increase by a positive magnitude toward a right end of the axis. The longitudinal g-forces approach a zero magnitude toward the center of the horizontal axis. Events having a negative g-force represent braking events, and events having a positive g-force represent acceleration events. As shown, the mean g-force for the detected events is approximately 0 g.

Table 1 lists several example longitudinal g-forces at several lower percentiles in distribution 530. As shown, lower percentiles in the range of 0.05 to 0.20 generally correspond to −0.36 to −0.30 g, respectively.

TABLE 1

| | | Standard | Decrease in |
|---|---|---|---|
| Percentile | G-force | Deviations | Speed (mph/s) |
| 0.05 | −0.36 | −4.80 | −7.89 |
| 0.10 | −0.32 | −4.27 | −7.02 |
| 0.15 | −0.31 | −4.13 | −6.80 |
| 0.20 | −0.30 | −4.00 | −6.58 |

Because the g-forces toward the left end of horizontal axis 532 increase by a negative magnitude, the listed g-forces correspond to braking maneuvers, and the lower percentiles correspond to increasingly greater negative-magnitude g-forces. Also shown in Table 1 are the respective standard deviations and decreases in speed (in miles per hour per second) for the g-forces at the respective percentiles.

Similarly, table 2 lists several example longitudinal g-forces at several upper percentiles in distribution 530. As shown, upper percentiles in the range of 99.95 to 99.83 generally correspond to 0.31 to 0.26 g, respectively.

TABLE 2

| | | Standard | Increase in |
|---|---|---|---|
| Percentile | G-force | Deviations | Speed (mph/s) |
| 99.95 | 0.31 | 4.14 | 6.80 |
| 99.9 | 0.28 | 3.74 | 6.14 |
| 99.87 | 0.27 | 3.60 | 5.91 |
| 99.83 | 0.26 | 3.47 | 5.70 |

Because the g-forces toward the right end of horizontal axis 532 increase by a positive magnitude, the listed g-forces correspond to acceleration maneuvers, and the higher percentiles correspond to increasingly greater positive-magnitude g-forces. Also shown in Table 2 are the respective standard deviations and increases in speed (in miles per hour per second) for the g-forces at the respective percentiles.

In an embodiment, threshold g-force 510 takes the form of (or includes) a threshold g-force associated with a given maneuver type, and a detected event having a g-force exceeding the threshold g-force takes the form of (or includes) a detected event having a g-force exceeding a threshold g-force associated with a type of the maneuver. For example, a threshold g-force associated with an acceleration maneuver may take the form of (or include) a positive threshold acceleration g-force. As another example, a threshold g-force associated with a braking maneuver may take the form of (or include) a negative threshold braking g-force. As a further example, a threshold g-force associated with a turning maneuver may take the form of (or include) a threshold turning g-force.

To illustrate, with reference to Table 1 above, the threshold g-force associated with a braking maneuver could be −0.31 g, which is the g-force of the bottom 0.15 percentile of detected events of distribution 530. In such an example, any detected event that is a braking maneuver would exceed the threshold if the g-force of the event exceeds −0.31 g. For instance, if detected events 500a and 500b were braking maneuvers having g-forces 502a and 502b of −0.32 g and −0.36 g, respectively, then the respective g-forces of both events would exceed the threshold g-force of −0.31 g associated with a braking maneuver. If a detected event is a maneuver of multiple maneuver types, then the detected event may be a detected harsh event if the g-force of the event exceeds the respective threshold g-force associated with either maneuver type or exceeds the respective threshold g-forces of both maneuver types, among other possibilities.

In an embodiment, the respective detected event of each of harsh events 302 takes the form of (or includes) a maneuver of a selected maneuver type 515. The selected maneuver type could take the form (or include) an acceleration maneuver, a braking maneuver, and/or a turning maneuver (e.g., as discussed above), among other possibilities. For example, in the embodiment illustrated in FIG. 5a, maneuver types 504a, 504b, 504c, and 504d of the respective maneuvers could each be maneuver types of selected maneuver type 515. In an embodiment, threshold g-force 510 takes the form of (or includes) a threshold g-force associated with selected maneuver type 515.

### Harsh-Event Score and Event-Penalty Scores

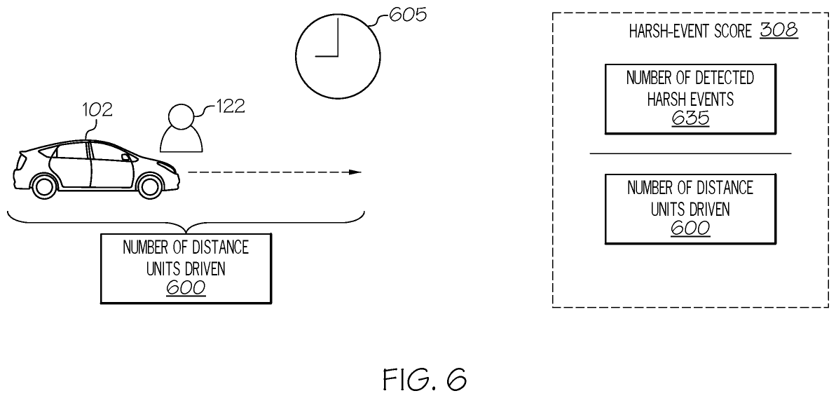

FIG. 6 depicts aspects of a harsh-event score, according to one or more embodiments described and illustrated herein. As shown, the at least one vehicle 102 is driven a number 600 of distance units by operator 122 during a period of time 605. Harsh-event score 308 takes the form of (or includes) a ratio of a number 635 of the detected harsh events 302 to the number 600 of distance units driven by operator 122 during period of time 605. In an embodiment, detected harsh events 302 includes harsh events performed by operator 122 of the at least one vehicle 102 driven number 600 of distance units by operator 122 during period of time 605.

The distance units may take the form of (or include) miles, nautical miles, kilometers, and/or any other distance unit. Period of time 605 could take the form of (or include) a day, a week, or a month. Additionally or alternatively, period of time 605 could take the form of any combination of one or more days, one or more weeks, or one or more months. Other examples of period of time 605 are possible as well.

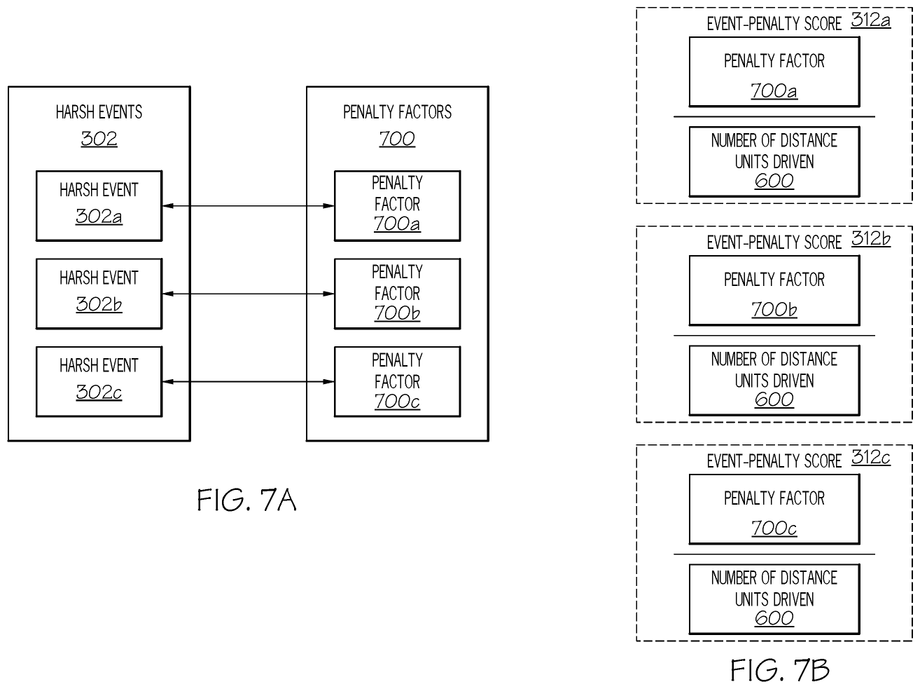

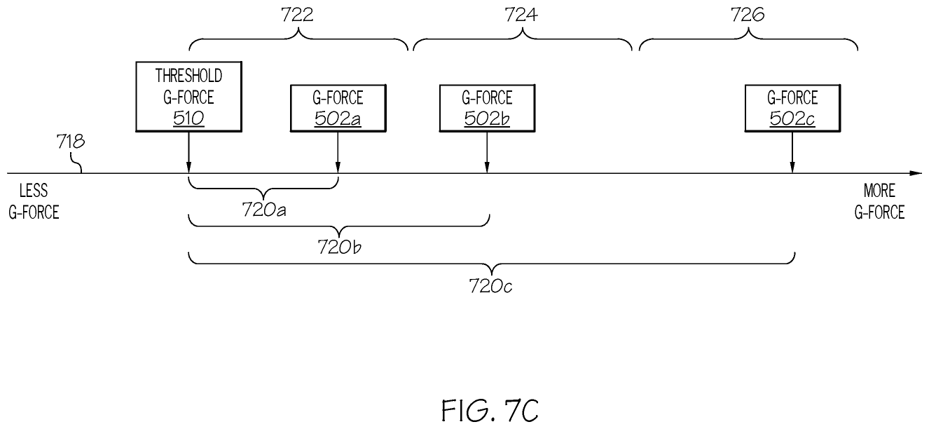

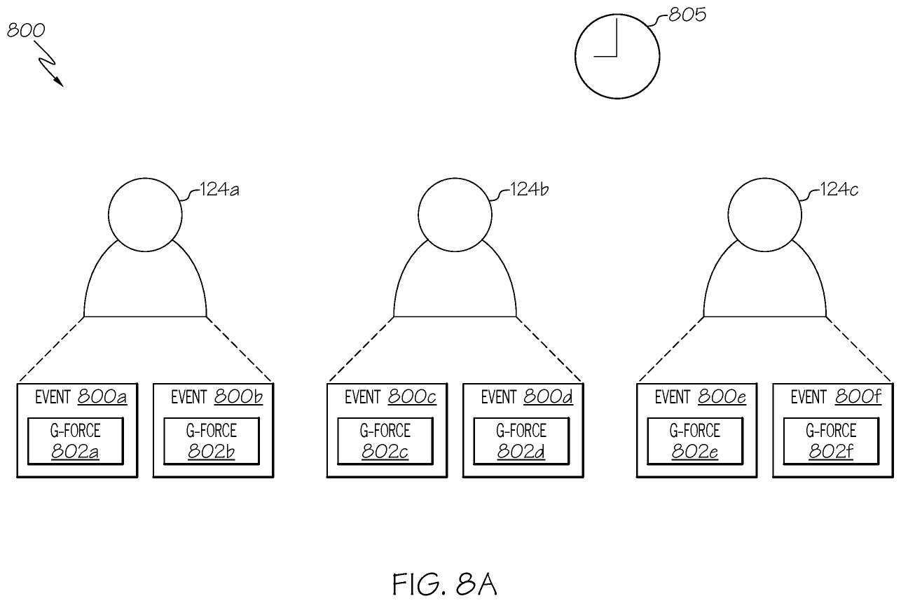

In an embodiment, the respective event-penalty score for each of detected harsh events 302 takes the form of (or includes) a respective ratio of a penalty factor associated with the detected harsh event to the number 600 of distance units driven by operator 122 during period of time 605. FIG. 7a depicts aspects of penalty factors associated with detected harsh events 302, and FIG. 7b depicts aspects of event-penalty scores for detected harsh events 302, according to one or more embodiments described and illustrated herein.

As shown in FIG. 7a, penalty factors 700 include respective penalty factors associated with each of detected harsh events 302, including penalty factors 700a, 700b, and 700c associated with harsh events 302a, 302b, and 302c, respectively. As shown in FIG. 7b, event-penalty score 312a takes the form of (or includes) a ratio of penalty factor 700a associated with harsh event 302a to the number 600 of distance units driven by operator 122 during period of time 605. Similarly, event-penalty score 312b takes the form of (or includes) a ratio of penalty factor 700b to the number 600 of distance units, and event-penalty score 312c takes the form of (or includes) a ratio of penalty factor 700c to the number 600 of distance units.

FIG. 7c depicts g-forces that exceed threshold g-force 510, according to one or more embodiments described and illustrated herein. As shown in FIG. 7c, threshold g-force 510, and g-forces 502a, 502b, and 502c of detected events 500a, 500b, and 500c, respectively, are shown on a horizontal axis 718. The left end of the axis represents less g-force, and the right end of the axis represent more g-force. The positions of the g-forces illustrated on the horizontal axis are based on the respective magnitudes of the g-forces. For example, threshold g-force 510 is positioned to the left of g-forces 502a, 502b, and 502c, representing that the threshold g-force is less than any of the other g-forces positioned on the axis. G-force 502c is positioned to the right of threshold g-force 510 and g-forces 502a and 502b, representing that g-force 502c is greater than any of the other g-forces positioned on the axis. G-forces 502a and 502b are both positioned between threshold g-force 510 and g-force 502c, and g-force 502a is positioned to the left of g-force 502b, indicating that g-force 502b is greater than g-force 502a, and indicating that g-forces 502a and 502b are greater than threshold g-force 510 but less than g-force 502c. As shown, g-forces 502a, 502b, and 502c each exceed threshold g-force 510.

Also shown are amounts 720a, 720b, and 720c that g-forces 502a, 502b, and 502c exceed threshold g-force 510, respectively. In an embodiment, the respective penalty factor associated with each of the detected harsh events 302 is based on an amount that the g-force of the respective detected event of the harsh event exceeds threshold g-force 510. In an example, penalty factor 700a is based on amount 720a that g-force 502a exceeds threshold g-force 510. Similarly, penalty factor 700b is based on amount 720b that g-force 502b exceeds threshold g-force 510, and penalty factor 700c is based on amount 720c that g-force 502c exceeds threshold g-force 510.

In an embodiment, the respective penalty factor associated with each of the detected harsh events 302 takes the form of (or includes) a penalty factor associated with a given range of g-forces that exceed threshold g-force 510. To illustrate, the embodiment of FIG. 7c includes respectively different ranges 722, 724, and 726 of g-forces that exceed threshold g-force 510. The lower bound of range 722 is just above threshold g-force 510. Range 724 is above range 722, with a lower bound just above the upper bound for range 724. Range 726 is above ranges 722 and 724, with a lower bound just above the upper bound for range 724, and with no upper bound. Penalty factors 700a, 700b, and 700c are associated with ranges 722, 724, and 726, respectively. In an example with reference to Table 1, threshold g-force 510 is −0.31 g. Range 722 includes g-forces that exceed −0.31 g but do not exceed −0.32 g. Additionally, range 724 includes g-forces that exceed −0.32 g but do not exceed −0.36 g, and range 726 includes g-forces that exceed −0.36 g.

The penalty factor may take the form of (or include) a number such as a real number, an integer, a non-zero number, and/or a zero, as examples. In an embodiment, the respective penalty factor associated with each of the detected harsh events 302 is a respective integer in the form of a zero, a one, or a two. For instance, penalty factor 700a could be zero, penalty factor 700b could be one, and penalty factor 700c could be two. Additionally, the penalty factor could indicate (or be associated with) a severity such as low, medium, or high, and higher severities could be associated with higher numbers. For example, penalty factors associated with low, medium, and high severities could take the form of (or include) integers zero, one, and two, respectively.

In an embodiment, the respective penalty factor associated with each of the detected harsh events 302 is positively (i.e., not negatively) correlated to the amount that the g-force of the respective detected event exceeds threshold g-force 510. For example, in FIG. 7c, range 724 of g-forces for penalty factor 700b is above range 722 of g-forces for penalty factor 700a, and therefore penalty factor 700b is greater than penalty factor 700a. Similarly, range 726 of g-forces for penalty factor 700c is above both ranges 722 and 724, and therefore penalty factor 700c is greater than both penalty factors 700a and 700b. In another embodiment, the respective penalty factor associated with each of the detected harsh events 302 is negatively (i.e., not positively) correlated to the amount that the g-force of the respective detected event exceeds threshold g-force 510.

### Metric Score Parameter and Driver-Event Ratios

In an embodiment, metric score parameter 314 is based on a given bottom percentile of respective driver-event ratios for each of the plurality of operators of vehicles 124. Each driver-event ratio takes the form of (or includes) a respective ratio of a number of events, performed by the respective operator during a given period of time and having respective g-forces exceeding the threshold g-force, to a respective number of distance units driven by the respective operator during the given period of time.

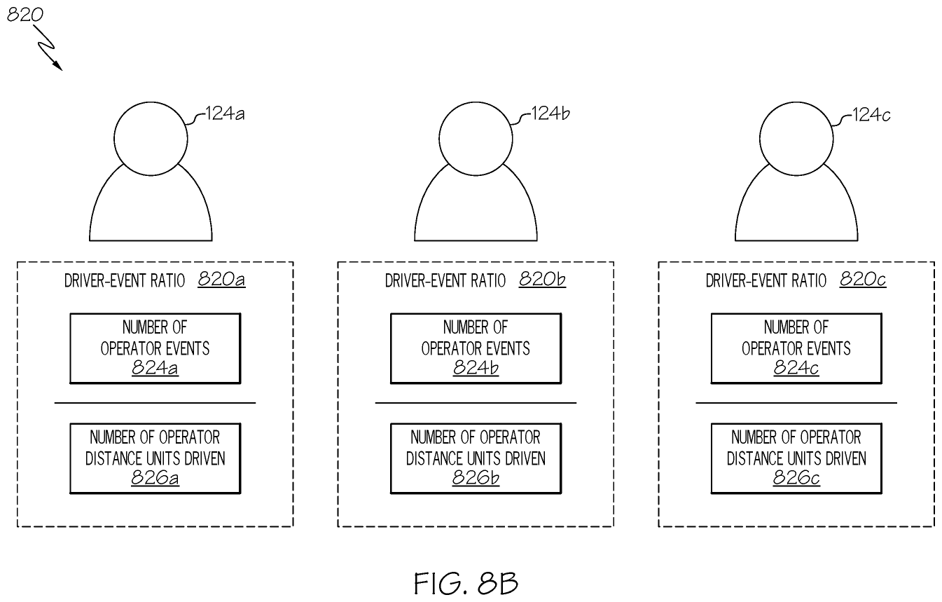

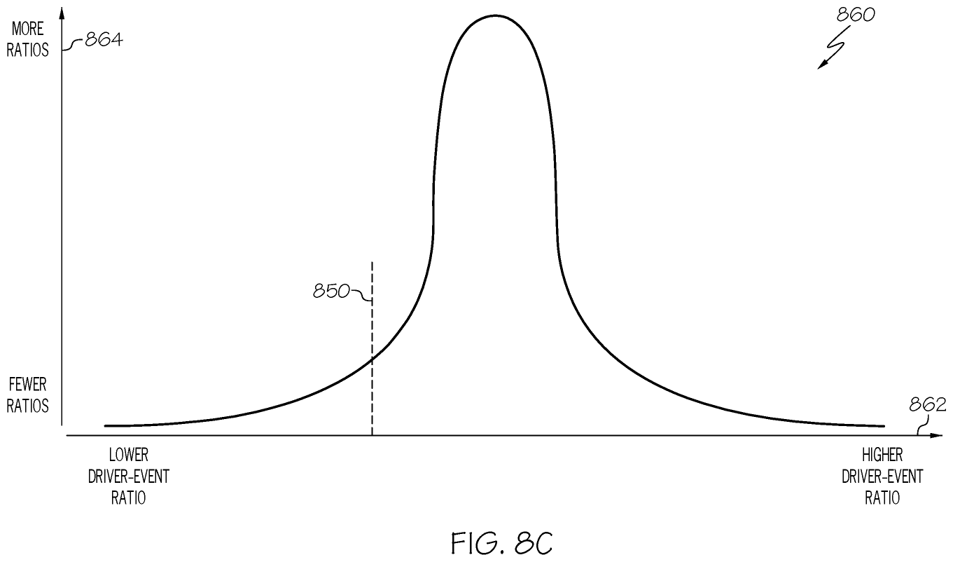

FIG. 8a depicts events performed by a plurality of vehicle operators, according to one or more embodiments described and illustrated herein. As shown in FIG. 8a, events 800 include events performed by the plurality of operators 124 of vehicles 104 during a period of time 805. The respective g-forces of events 800 each exceed threshold g-force 510. Period of time 805 could be earlier than period of time 605 during which harsh events 302 are performed by operator 122. For instance, events 800 may have been performed months or years before period of time 605, and anonymized driving data for events 800 may have been stored in a database. The driver-event ratios may be based on this historical anonymized driving data.

In an embodiment, events 800 include events 800a and 800b that are performed by operator 124a and that have g-forces 802a and 802b, respectively. Events 800 further include events 800c and 800d that are performed by operator 124b and that have g-forces 802c and 802d, respectively, and also include events 800e and 800f that are performed by operator 124c and that have g-forces 802e and 802f, respectively.

Similar to periods of time 505 and 605, period of time 805 could take the form of (or include) a day, a week, or a month. Additionally or alternatively, period of time 805 could take the form of any combination of one or more days, one or more weeks, or one or more months. Other examples of period of time 805 are possible as well. In an embodiment, period of time 805 and period of time 505 are the same period of time, and events 800 and the events of distribution 530 are the same events.

In an embodiment, each of the events performed by a respective operator (among the plurality of operators 124) is a respective maneuver of one or more maneuver types, such as an acceleration maneuver, a braking maneuver, and/or a turning maneuver, among other possibilities as discussed above. In such an embodiment, the threshold g-force takes the form of (or includes) a threshold g-force associated with a given maneuver type, and each of the events performed by the respective operator having a g-force exceeding the threshold g-force takes the form of (or includes) an event having a g-force exceeding a threshold g-force associated with a type of the maneuver. In an embodiment, the respective events of each of the driver event ratios take the form of (or include) respective maneuvers of selected maneuver type 515.

FIG. 8b depicts respective driver-event ratios for each of a plurality of vehicle operators, according to one or more embodiments described and illustrated herein. In the illustrated embodiment, driver-event ratios 820 include driver-event ratio 820a, driver-event ratio 820b, and driver-event ratio 820c for operators 124a, 124b, and 124c of the plurality of operators 124, respectively. Driver-event ratio 820a takes the form of (or includes) a ratio of a number 824a of events, performed by operator 124a during period of time 805 and having respective g-forces exceeding threshold g-force 510, to a number 826a of distance units driven by operator 124a during period of time 805. Similarly, driver-event ratio 820b takes the form of (or includes) a ratio of a number 824b of events, performed by operator 124b during period of time 805 and having respective g-forces exceeding threshold g-force 510, to a number 826b of distance units driven by operator 124b during period of time 805. Additionally, driver-event ratio 820c takes the form of (or includes) a ratio of a number 824c of events performed by operator 124c during period of time 805 to a number 826c of distance units driven by operator 124c during period of time 805. The distance units may take the form of (or include) miles, nautical miles, kilometers, and/or any other distance unit.

FIG. 8c depicts a distribution 860 of driver-event ratios 820, according to one or more embodiments described and illustrated herein. A horizontal axis 862 indicates a driver-event ratio and a vertical axis 864 indicates a number of the plurality of operators 124 having the driver-event ratio indicated on the horizontal axis. The left end of the axis represents a higher driver-event ratio, and the right end of the axis represents a lower driver-event ratio.

A bottom percentile 850 represents a bottom percentile of driver-event ratios 820. The percentile could be a number of standard deviations from a mean of the respective driver-event ratios, for example. In an embodiment, bottom percentile 850 of driver-event ratios 820 takes the form of (or includes) a bottom 5 percentile, a bottom 3 percentile, a bottom 0.2 percentile, a bottom 0.15 percentile, a bottom 0.1 percentile, or a bottom 0.05 percentile.

Tables 3 and 4 lists several example driver-event ratios at several lower percentiles in distribution 860. As shown in Table 3, if the g-force threshold for acceleration maneuvers were set to 0.28 g and period of time 805 were January (of an unspecified year), then a bottom fifth percentile of driver-event ratios 820 would be 0.254 events per distance unit (miles in this example), and a bottom third percentile would be 0.316 events per mile.

TABLE 3

| Acceleration | | Event/Mile Ratio | Events/Mile Ratio |
|---|---|---|---|
| (G) | Month | (Bottom 5 Percentile) | (Bottom 3 Percentile) |
| 0.26 | December | 0.382 | 0.460 |
| | January | 0.390 | 0.478 |
| 0.27 | December | 0.313 | 0.380 |
| | January | 0.316 | 0.389 |
| 0.28 | December | 0.252 | 0.310 |
| | January | 0.254 | 0.316 |
| 0.31 | December | 0.124 | 0.165 |
| | January | 0.123 | 0.160 |

Similarly, as shown in Table 4, if the g-force threshold for braking maneuvers were set to −0.31 g and period of time 805 were January (of an unspecified year), then a bottom fifth percentile of driver-event ratios 820 would be 0.251 events per distance unit (miles in this example), and a bottom third percentile would be 0.305 events per mile.

TABLE 4

| Acceleration | | Event/Mile Ratio | Events/Mile Ratio |
|---|---|---|---|
| (G) | Month | (Bottom 5 Percentile) | (Bottom 3 Percentile) |
| −0.30 | December | 0.294 | 0.350 |
| | January | 0.306 | 0.369 |
| −0.31 | December | 0.240 | 0.291 |
| | January | 0.251 | 0.305 |
| −0.32 | December | 0.197 | 0.242 |
| | January | 0.206 | 0.253 |
| −0.36 | December | 0.085 | 0.100 |
| | January | 0.086 | 0.111 |

Driver-scoring device 200, subsequent to determining penalty score 304, may present the penalty score via a user interface. For example, the penalty score may be presented to operator 122 or an employer of the operator. Penalty scores for multiple operators could be determined and presented via the user interface. The user interface could take the form of (or include) user interface 210, a user interface of user terminal 108, or another user interface.

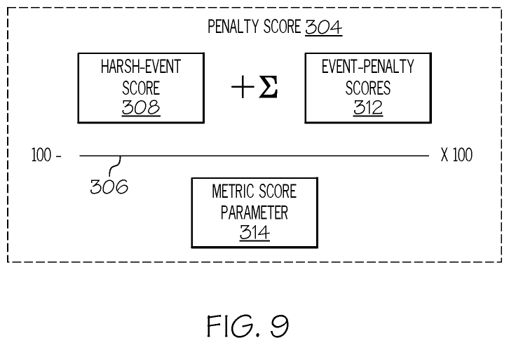

Ratio 306 of penalty score 304 may be added to or subtracted from a number, multiplied or divided by a number, or any combination of these or other operations. For instance, FIG. 9 depicts aspects of determining a penalty score, according to one or more embodiments described and illustrated herein. As shown, determining a penalty score 304 may include multiplying ratio 306—of harsh-event score 308 added to the sum of event-penalty scores 312, to a metric score parameter 314—by one hundred and subtracting the multiplied ratio from one hundred. In the embodiment of FIG. 9, the penalty score may take the form of a number between zero and one hundred. In such an embodiment, a higher penalty score may correspond to generally optimal driving by operator 122, and a lower penalty score may correspond to less-optimal driving.

### Example Method

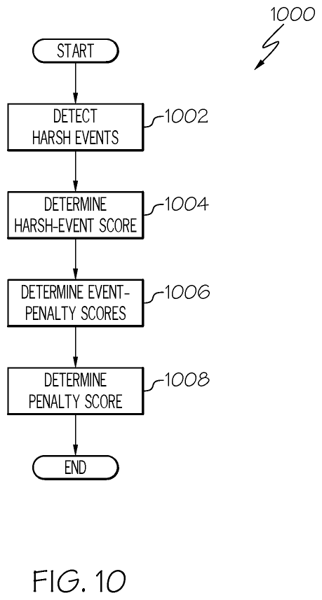

FIG. 10 depicts a flowchart of a method carried out by a driver-scoring device, according to one or more embodiments described and illustrated herein. As shown, a method 1000 begins at step 1002 with driver-scoring device 200 detecting the one or more harsh events 302 performed by operator 122 of the at least one vehicle 102 driven a number 600 of distance units by operator 122 during period of time 605. Each of the detected harsh events 302 takes the form of (or includes) a respective detected event performed by operator 122 and having a g-force exceeding threshold g-force 510.

Driver-scoring device 200 may detect one or more events 500 performed by operator 122 during period of time 605. In an embodiment, for each of the detected events 500, driver-scoring device 200 makes a determination whether the detected event has a g-force that exceeds threshold g-force 510. Detecting the one or more harsh events 302 may include, for each of the detected events 500, identifying the detected event as a harsh event if the determination is that the detected event has a g-force that exceeds threshold g-force 510.

In a further embodiment, for each of the detected events 500, driver-scoring device identifies a respective maneuver type of the detected event. Detecting the one or more harsh events 302 may include, for each of the detected events 500, identifying the detected event as a harsh event if the identified maneuver type is selected maneuver type 515. Additionally or alternatively, for each of the detected events 500, driver-scoring device 200 may make a determination whether the detected event has a g-force that exceeds a threshold g-force associated with the identified maneuver type. Detecting the one or more harsh events 302 may include, for each of the detected events 500, identifying the detected event as a harsh event if the determination is that the detected event has a g-force that exceeds the threshold g-force associated with the identified maneuver type.

In an embodiment, for each of the detected events 500, driver-scoring device 200 makes a determination whether the detected event was performed by operator 122. Detecting the one or more harsh events 302 may include, for each of the detected events 500, identifying the detected event as a harsh event if the determination is that the detected event was performed by operator 122. In a further embodiment, for each of the detected events 500, driver-scoring device 200 makes a determination whether the detected event was performed during period of time 605. Detecting the one or more harsh events 302 may include, for each of the detected events 500, identifying the detected event as a harsh event if the determination is that the detected event was performed during period of time 605.

At step 1004, driver-scoring device 200 determines harsh-event score 308, which (as discussed above) takes the form of (or includes) the ratio of the number 635 of the detected harsh events 302 to the number 600 of distance units driven by operator 122 during period of time 605. In an embodiment, determining harsh-event score 308 includes driver-scoring device 200 determining the number 635 of the detected harsh events 302, and/or determining the number 600 of distance units driven by operator 122 during period of time 605. In an embodiment, determining harsh-event score 308 includes driver-scoring device 200 determining the ratio of the number 635 of the detected harsh events 302 to the number 600 of distance units driven by operator 122 during period of time 605. In such an embodiment, the number 635 of the detected harsh events 302 may include the determined number of harsh event. Additionally or alternatively, the number 600 of distance units may include the determined number of distance units.

At step 1006, driver-scoring device 200 determines event-penalty scores 312, which includes determining the respective event-penalty score for each of the detected harsh events 302. As discussed above, the respective event-penalty score for each of the detected harsh events takes the form of (or includes) a respective ratio of the penalty factor associated with the detected harsh event to the number 600 of distance units driven by operator 122 during period of time 605.

In an embodiment, determining the event-penalty scores includes, for each of the detected harsh events 302, driver-scoring device 200 determining the ratio of the penalty factor associated with the detected harsh event to the number 600 of distance units driven by operator 122 during period of time 605. Determining the ratio may include identifying the penalty factor associated with the detected harsh event, determining the number 600 of distance units driver by operator 122 during period of time 605, and determining a ratio of the identified penalty factor to the determined number of distance units.

Identifying the penalty factor associated with the detected harsh event may include determining the amount that the g-force of the respective detected event of the harsh event exceeds threshold g-force 510, and may further include identifying the penalty factor based on the determined amount. In an embodiment, one or more mutually-exclusive ranges of g-forces that exceed threshold g-force 510 are associated with respective penalty factors. In such an embodiment, identifying the penalty factor may include identifying which of the one or more ranges includes the g-force of the respective detected event of the harsh event, and may further include identifying the penalty factor associated with the identified range.

At step 1008, driver-scoring device 200 determines penalty score 304, which (as discussed above) takes the form of (or includes) ratio 306, of harsh-event score 308 added to the sum of event-penalty scores 312, to the metric score parameter 314.

In an embodiment, determining penalty score 304 includes determining metric score parameter 314, which is based on a given bottom percentile of the respective driver-event ratios for each of the plurality of operators 124 of vehicles 104.

Determining metric score parameter 314 may include determining the driver-event ratios, each of which takes the form of (or includes) a respective ratio of a number of events, performed by the respective operator during period of time 805 and having respective g-forces exceeding threshold g-force 510, to a respective number of distance units driven by the respective operator during period of time 805.

In some embodiments, data for determining the driver-event ratios is stored in a database. The data includes historical (e.g., anonymized) driving data for the plurality of operators 124. For example, the data may include, for each detected event, an identification of the operator performing the event, an identification of the vehicle that was operated when the event was detected, an indication of the time at which the event was detected, and a direction and magnitude of the g-force of the event, as examples. The data may further include, for each operator, a cumulative number of miles driven by the respective operator at respective times (e.g., over a given period of days, weeks, or months).

Determining the driver-event ratios may include, for each of the plurality of operators, determining a respective ratio of the number of events, performed by the operator during period of time 805 and having respective g-forces exceeding threshold g-force 510, to the number of distance units driven by the operator during period of time 805. Determining the ratio may include determining the number of events performed by the operator during period of time 805 and having respective g-forces exceeding threshold g-force 510, and may include determining the number of distance units driven by the operator during period of time 805.

### Conclusion

It should now be understood that one or more embodiments described herein are directed to driver-scoring systems, driver-scoring devices, and methods carried out by driver-scoring systems and driver-scoring devices for determining a penalty score of a vehicle operator. In some embodiments, a driver-scoring device detects one or more harsh events performed by an operator of at least one vehicle driven a number of distance units by the operator during a first period of time. Each of the detected harsh events includes a respective detected event performed by the operator and having a g-force exceeding a threshold g-force. The driver-scoring device determines a penalty score that includes a ratio of a harsh-event score added to a sum of respective event-penalty scores for each of the detected harsh events to a metric score parameter. The harsh-event score includes a ratio of a number of the detected harsh events to the number of distance units driven by the operator during the first period of time. The respective event-penalty score for each of the detected harsh events includes a respective ratio of a penalty factor associated with the detected harsh event to the number of distance units driven by the operator during the first period of time. The metric score parameter is based on a given bottom percentile of respective driver-event ratios for each of a plurality of operators of vehicles. Each driver-event ratio includes a respective ratio of a number of events, performed by the respective operator during a second period of time and having respective g-forces exceeding the threshold g-force, to a respective number of distance units driven by the respective operator during the second period of time.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method carried out by a driver-scoring device, the method comprising:
detecting one or more harsh events performed by an operator of at least one vehicle driven a number of distance units by the operator during a first period of time, wherein each of the detected harsh events comprises a respective detected event performed by the operator and having a g-force exceeding a threshold g-force; and
determining a penalty score comprising a ratio of a harsh-event score added to a sum of respective event-penalty scores for each of the detected harsh events to a metric score parameter, wherein:
the harsh-event score comprises a ratio of a number of the detected harsh events to the number of distance units driven by the operator during the first period of time,
the respective event-penalty score for each of the detected harsh events comprises a respective ratio of a penalty factor associated with the detected harsh event to the number of distance units driven by the operator during the first period of time,
the metric score parameter is based on a given bottom percentile of respective driver-event ratios for each of a plurality of operators of vehicles, and
each driver-event ratio comprises a respective ratio of a number of events, performed by the respective operator during a second period of time and having respective g-forces exceeding the threshold g-force, to a respective number of distance units driven by the respective operator during the second period of time.

2. The method of claim 1, wherein the respective penalty factor associated with each of the detected harsh events is based on an amount that the g-force of the respective detected event of the detected harsh event exceeds the threshold g-force.

3. The method of claim 2, wherein:
determining the penalty score comprises determining the respective event-penalty score for each of the detected harsh events, and
determining the respective event-penalty score for each of the detected harsh events comprises:
determining the amount that the g-force of the respective detected event of the detected harsh event exceeds the threshold g-force;
determining the penalty factor associated with the detected harsh event based on the determined amount; and
determining the respective ratio of the determined penalty factor associated with the detected harsh event to the number of distance units driven by the operator during the first period of time.

4. The method of claim 2, wherein the respective penalty factor associated with each of the detected harsh events is a respective integer comprising a zero, a one, or a two, and is positively correlated to the amount that the g-force of the respective detected event exceeds the threshold g-force.

5. The method of claim 1, wherein the given bottom percentile of respective driver-event ratios comprises a bottom 5 percentile, a bottom 3 percentile, a bottom 0.2 percentile, a bottom 0.15 percentile, a bottom 0.1 percentile, or a bottom 0.05 percentile.

6. The method of claim 1, wherein:
the respective detected event of each of the detected harsh events comprises a respective maneuver of a selected maneuver type,
the respective events of each of the driver-event ratios comprise respective maneuvers of the selected maneuver type, and
the threshold g-force comprises a threshold g-force associated with the selected maneuver type.

7. The method of claim 6, wherein:
the selected maneuver type comprises at least one of an acceleration maneuver, a braking maneuver, and a turning maneuver,
the threshold g-force associated with the acceleration maneuver comprises a positive threshold acceleration g-force,
the threshold g-force associated with the braking maneuver comprises a negative threshold braking g-force, and
the threshold g-force associated with the turning maneuver comprises a threshold turning g-force.

8. The method of claim 1, wherein determining the penalty score comprises multiplying the ratio, of the harsh-event score added to the sum of the respective event-penalty scores for each of the detected harsh events to the metric score parameter, by one hundred and subtracting the multiplied ratio from one hundred.

9. The method of claim 1, wherein the respective detected event of each of the detected harsh events comprises a maneuver of a respective maneuver type and has a g-force exceeding a threshold g-force associated with the maneuver type.

10. The method of claim 1, wherein each of the events performed by the respective operator during the second period of time and having respective g-forces exceeding the threshold g-force comprises a maneuver of a respective maneuver type and has a g-force exceeding a threshold g-force associated with the maneuver type.

11. A driver-scoring device comprising a processor and a non-transitory computer-readable storage medium comprising instructions that, when executed by the processor, cause the driver-scoring device to:
detect one or more harsh events performed by an operator of at least one vehicle driven a number of distance units by the operator during a first period of time, wherein each of the detected harsh events comprises a respective detected event performed by the operator and having a g-force exceeding a threshold g-force; and
determine a penalty score comprising a ratio of a harsh-event score added to a sum of respective event-penalty scores for each of the detected harsh events to a metric score parameter, wherein:
the harsh-event score comprises a ratio of a number of the detected harsh events to the number of distance units driven by the operator during the first period of time,
the respective event-penalty score for each of the detected harsh events comprises a respective ratio of a penalty factor associated with the detected harsh event to the number of distance units driven by the operator during the first period of time,
the metric score parameter is based on a given bottom percentile of respective driver-event ratios for each of a plurality of operators of vehicles, and
each driver-event ratio comprises a respective ratio of a number of events, performed by the respective operator during a second period of time and having respective g-forces exceeding the threshold g-force, to a respective number of distance units driven by the respective operator during the second period of time.

12. The driver-scoring device of claim 11, wherein the respective penalty factor associated with each of the detected harsh events is based on an amount that the g-force of the respective detected event of the detected harsh event exceeds the threshold g-force.

13. The driver-scoring device of claim 11, wherein the respective detected event of each of the detected harsh events comprises a maneuver of a respective maneuver type and has a g-force exceeding a threshold g-force associated with the maneuver type.

14. The driver-scoring device of claim 13, wherein:
the respective maneuver type comprises at least one of an acceleration maneuver, a braking maneuver, and a turning maneuver,
the threshold g-force associated with the acceleration maneuver comprises a positive threshold acceleration g-force,
the threshold g-force associated with the braking maneuver comprises a negative threshold braking g-force, and
the threshold g-force associated with the turning maneuver comprises a threshold turning g-force.

15. The driver-scoring device of claim 11, wherein each of the events performed by the respective operator during the second period of time and having respective g-forces exceeding the threshold g-force comprises a maneuver of a respective maneuver type and has a g-force exceeding a threshold g-force associated with the maneuver type.

16. A method carried out by a driver-scoring device, the method comprising:
detecting one or more harsh events performed by an operator of at least one vehicle driven a number of distance units by the operator during a first period of time, wherein each of the detected harsh events comprises a respective detected event performed by the operator and having a g-force exceeding a threshold g-force;
determining a harsh-event score comprising a ratio of a number of the detected harsh events to the number of distance units driven by the operator during the first period of time;
determining, for each of the detected harsh events, a respective event-penalty score comprising a respective ratio of a penalty factor associated with the detected harsh event to the number of distance units driven by the operator during the first period of time; and
determining a penalty score comprising a ratio of the determined harsh-event score added to a sum of the determined respective event-penalty scores to a metric score parameter, wherein:
the metric score parameter is based on a given bottom percentile of respective driver-event ratios for each of a plurality of operators of vehicles, and
each driver-event ratio comprises a respective ratio of a number of events, performed by the respective operator during a second period of time and having respective g-forces exceeding the threshold g-force, to a respective number of distance units driven by the respective operator during the second period of time.

17. The method of claim 16, wherein the respective penalty factor associated with each of the detected harsh events is based on an amount that the g-force of the respective detected event of the detected harsh event exceeds the threshold g-force.

18. The method of claim 16, wherein the respective detected event of each of the detected harsh events comprises a maneuver of a respective maneuver type and has a g-force exceeding a threshold g-force associated with the maneuver type.

19. The method of claim 18, wherein:
the respective maneuver type comprises at least one of an acceleration maneuver, a braking maneuver, and a turning maneuver,
the threshold g-force associated with the acceleration maneuver comprises a positive threshold acceleration g-force,
the threshold g-force associated with the braking maneuver comprises a negative threshold braking g-force, and
the threshold g-force associated with the turning maneuver comprises a threshold turning g-force.

20. The method of claim 16, wherein each of the events performed by the respective operator during the second period of time and having respective g-forces exceeding the threshold g-force comprises a maneuver of a respective maneuver type and has a g-force exceeding a threshold g-force associated with the maneuver type.
